(19) United States
(12) Patent Application Publication
(10) Pub. No.: US 2005/0220980 A1
(43) Pub. Date: Oct. 6, 2005

(54) Use of pre-cooked cereal and tubular starch in high protein foods products

(76) Inventor: Massoud Kazemzadeh, Bloomington, MN (US)

Correspondence Address: Patterson, Thuente, Skaar & Christensen, P.A., 4800 IDS Center, 80 South 8th Street, Minneapolis, MN, 55402-2100, US

(21) Appl. No.: 11/119,876

(22) Filed: May 2, 2005

Related U.S. Application Data
(63) Continuation-in-part of application No. 10/959,595, filed on Oct. 6, 2004, now abandoned.
(60) Provisional application No. 60/509,030, filed on Oct. 6, 2003.

(51) Int. Cl. A23D 7/00

(52) U.S. Cl. 426/656

(57) ABSTRACT

The present invention relates to the utilization of pre-cooked cereal tubular starch such as oat flour, corn flour, corn starch, rice flour, rice starch, potato starch, pre-gelled potato starch, Cassava starch, or tapioca starch in the making of high protein pretzels and snacks as well as food particles which posses a lower bulk density and lighter crunch in the finished products. Such a matrix combined with a gas infused plasticizing agent in the making of pretzels, high protein pretzels, and snacks will result in an even lighter texture in the finished product.

### REFERENCE TO RELATED APPLICATION

This application is a continuation-in-part of U.S. application Ser. No. 10/959,595 filed Oct. 6, 2004, which claims the benefit of U.S. Provisional Application No. 60/509,030 filed Oct. 6, 2003, which are incorporated herein in their entirety by reference.

### FIELD OF THE INVENTION

The present invention relates generally to a method of preparing starch-containing food products that exhibit enhanced nutritional characteristics. More particularly, the present invention relates to the use of pre-cooked cereal and tubular starch for food products.

### BACKGROUND OF THE INVENTION

Today the population of most of the developed countries and cities are facing a great epidemic of obesity and over weight as well as sensitivity and allergic reaction due to lack of proper diet.

The concept of low carbohydrate diets has become the most acceptable solution for the majority of the population with obesity problem. This includes individuals who are grossly obese as well as children and those who wish to maintain their weight and shape. Another field, which has supported this thought, has been the sport/nutrition centers, which promote high protein drinks for muscle builders and weight management via food intake and trainings.

According to Dean Ornish, MD. in Lifestyle Program “high protein diets help people lose weight because they are based partially on science, which is what makes them seductive. The high-protein advocates are right when they say that people in the United States eat too many simple carbohydrates like sugars, white flour, and white rice. These foods are absorbed quickly, causing blood sugar to spike, which in turn provokes an insulin response that accelerates the conversion of calories to fat. There is a clear benefit to reducing the intake of simple carbohydrates.

So the diagnosis is correct: we are eating too many simple carbohydrates. But the cure is wrong. The solution is not to go from simple carbohydrates to pork rinds and bacon, but from simple carbohydrates to whole foods with complex carbohydrates like whole-wheat, brown rice, and fruits, vegetables, grains and legumes in their natural forms. These foods are naturally high in fiber, which slows their absorption, preventing a rapid rise in blood sugar. Fiber also fills you up before you eat too many calories, whereas you can eat large amounts of sugar without feeling full. Best of all, these foods contain at least 1,000 substances that have anti-cancer, anti-heart disease, and anti-aging properties.

Then one may ask why are the snacks and the cereals as well as most of our food items consumed on daily bases between meals are so heavily filled with fats simple carbohydrates and sugars. The only logical explanation is that the most inexpensive component of the food is starches, sugars and fats while the most expensive components are fiber, proteins and complex carbohydrates.

The processing techniques that are presently being used to produce such snacks and cereals do not lend themselves to the production of high protein and high fiber type products and thus new techniques and new equipment are needed to give the capability of the manufacturer to produce good quality high protein and fiber snacks and cereals.

Commercial processing of foods can involve heating, cooling, drying, application of chemicals, fermentation, irradiation, or various other treatments. Of the preceding options, heating is most common. Heating is commonly done to inactivate microorganisms, to inactivate endogenous enzymes that cause oxidative and hydrolytic changes in foods during storage, and to transform an unappealing blend of raw food ingredients in to a wholesome and organoleptically appealing food.

In addition proteins such as bovine β-lactoglobulin, α-lactalbumin, and soy protein, which sometimes cause allergenic or hypersensitive responses, can sometimes be rendered innocuous in this regard. Unfortunately, the beneficial effects achieved by heating proteinaceous foods are generally accompanied by changes that can adversely affect the nutritive values and functional properties of proteins.

Most food proteins are denatured when exposed to moderate heat treatment (60-90° C., for 1 hour or less). Extensive denaturation of proteins often results in insolubilization, which can impair those functional properties that are dependent on solubility. From nutritional standpoint partial denaturation of proteins often improves the digestibility and biological availability of essential amino acids. Several purified plant proteins and egg protein preparations even though free of protease inhibitors, exhibit poor in vitro and in vivo digestibility. Moderate heating improves their digestibility without developing toxic derivatives.

Moderate heat treatment of foods also inactivates several enzymes, such as proteases, lipases, lipoxygenases, amylases, polyphenoloxidases, and other oxidative and hydrolytic enzymes. Failure to inactivate these enzymes properly will result in off flavors, rancidity, textural changes, and discoloration of food during storage.

Moderate heat treatment is particularly beneficial for plant proteins, because they usually contain proteinaceous antinutritional factors. Legume and oilseed proteins contain several trypsin and chymotrypsin inhibitors, which impair efficient digestion of protein and thus reduce their biological availability. Legume and oilseed proteins also contain lectins, which are glycoproteins. These compounds are also known as phytohemagglutinins because they cause agglutination of red blood cells. Lectins exhibit a high binding affinity for carbohydrates. When consumed by humans, lectins impair protein digestion and cause intestinal malabsorption of other nutrients.

When proteins are heated above 200° C., as is commonly found on food surfaces during broiling, baking, and grilling, amino acid residues undergo decomposition and pyrolysis. Several of the pyrolysis products have been isolated and identified from broiled and grilled meats, and they are highly mutagenic as determined by the Ames test.

Several food proteins contain both intra- and intermolecular cross-links, such as disulfide bonds in globular proteins, demosine, and isodesmosine; and di- and trityrosine-type cross links in fibrous proteins such as keratin, elastin, resilin, and collagen. Heating of proteins in an alkaline pH, results in abstraction derivative of Cys, cystine, and phosphosoerine undergoes β-elimination reaction, leading to formation of highly reactive dehydoalanine residue (DHA). DHA formation can also occur via a one step mechanism without formation of the carbanion.

Once formed, the highly reactive DHA residues react with nucleophilic groups, such as the ε-amino group of lysyl residue, the thiol group of Cys residue, the δ-amino group of ornithine (formed from decomposition of arginine), or a histidyl residue, resulting in cross linkage between the protein molecules.

As the demand on vegetable, whey, meat proteins, fibers, and fat increase in the formulation to replace simple starch and sugars, the production of light textured product with good taste becomes a major problem for the food engineers.

The starch portion of the recipe, which is both responsible for the increasing of the glycemic index as well as improving the textural quality of the food piece, can be of great value to a food engineer, especially those starches which are dominantly made from pre-cooked cereal and tubular sources such as potato, Cassava, Tapioca.

Among the snacks commonly consumed in the western countries are the various shapes and sizes of pretzels, which are salted or coated with chocolate.

Most snack and cereal manufacturers use extrusion cooking as an efficient and continuous process of manufacturing these items. The most favorable products that can easily be manufactured with such systems are the formulation of foods that are high in starch-based components. Starches are thermoplastic in nature. They can easily be melted and formed under pressure and in the presence of a plasticizing agent, such as water, to achieve a given product with low densities and light crunchy textures.

On the other hand, the protein portion of the formula is usually thermosetting in nature and is very difficult to control during processing. The same problem exists during the baking process where the plasticizers, such as fat, water, or various solutions, are converted into steam during baking, thus making the dough rise and making the texture of the finished product very light.

As the market demand increases for low carbohydrate products, more emphasis in formulation of products is placed on reducing the simple starches and increasing the fiber, protein, and fat portion of the formula. This process inadvertently affects the bulk density and textural profile of the finished product and results in higher bulk density products with heavier and harder crunch texture.

### SUMMARY OF THE INVENTION

An embodiment of the present invention is directed to using pre-cooked cereal or tubular starch in making a variety of food products. Food products prepared according to the method of the present invention exhibit a lower bulk density and a lighter crunch than similar food product made without the pre-cooked cereal and/or tubular starch.

### DETAILED DESCRIPTION OF THE PREFERRED EMBODIMENTS

In the method of the invention, pre-cooked cereal and/or tubular starches are used in preparing high protein food products such as pretzels, snacks and cereals. Food products produced according to the invention exhibit advantageous bulk density and crunch when compared to prior food products.

Starches are found as water-insoluble granules that constitute the reserve carbohydrates of plant. On heating dispersions in water, the granules absorb water and swell. The viscosity of the dispersion increases until, if heating is continued, the granules swell to the point of rupture and collapse, in most cases. The viscosity of the solution then decreases. Generally cereal starches tend to give opaque dispersions, while root starches tend to give clear dispersions. Among the starches, which are used in formulation of high protein products are corn starch, corn flour, waxy maize starches, sago starch, cassava starch, tapioca, potato starch and rice flour.

Cornstarch or corn flour, which is the most commonly used product and source of starch. When an aqueous suspension is heated, viscosity develops slowly, thins out after peak viscosity, and tends to be opaque and gel structure is formed when cooled rapidly.

Waxy maize starches, which are mostly amylopectin, show no or little tendency to gel on cooling of heated aqueous suspensions. On heating within an aqueous solution, they tend to pass rapidly thorough the region of maximum viscosity and tend to thin out rapidly.

Sago starch, obtained from stem of the sago palm, behaves somewhat similar to gel but tends to be expensive and not easily available. This starch shows much less tendency to gel but behaves similar to cornstarch.

Cassava (manioc) starch is made from tuber of the tropical plant Manihot utilissima. It is the dietary staple in many tropical countries. Although it is an extremely poor source of protein, the plant grows well even in poor soil, and is extremely hardy, withstanding considerable drought. It is one of the most prolific crops, yielding up to 13 million kcal/acre, compared with Yam 9 million and Sorghum or Maize 1 million. Cassava root contains cyanide, and before it can be eaten it must be grated and left in the open to allow the cyanide to evaporate. The leaves are also eaten as vegetable, and the tuber is the source of Tapioca.

Tapioca starch dose not show significant viscosity “peak” and shows little tendency to gel but is considered as an expensive source of starch. It tends to have a good flavor and excellent textural and expansion capability.

Potato starch (farina) shows a marked viscosity when heated and peaks at lower temperatures than cereals starches beyond which it tends to thin out very rapidly. This trait is also indicative of the elastic nature of potato starch after high-pressure extrusion.

Rice flour tends to develop viscosity between that of corn and wheat flour, but with higher gelatinization temperature, again developing a gel during cooling. Rice flour tends to be stable in acetic acid system and has been found to be of value in piccalilli formulation.

However, the use of pre-cooked starches and/or tubular starches is not common and has been limited to puddings or to hot cereals such as oatmeal, and gel forming like foods such as sauces and toppings. Our experience has been the use of potato starch and tapioca starch tend to behave the best in the making of baked products such as pretzels, snacks and the like when combined with Soya flour or Soya and whey proteins.

Use of these starches by themselves in making of the pretzels, snacks, and cereals tend to result in hard texture due to the elastic nature of the starch but when components such as Soya flour, Soya protein or whey proteins are added, the final product has an excellent light textural profile as well as good mouth feel and exceptional taste.

Based on our findings, the tubular starches such as potato, tapioca and similar products tend to give the best result if combined with some proteins from Soya, or Whey in concentrations of about 5 to about 60 percent by weight.

Most tubular starches tend to have a great capability to expand but contain a great deal of internal elastic bonding that causes them to collapse and draw back to a tighter matrix once the thermal energy is removed. This process thereby results in a higher bulk density and harder crunch.

Using the process and the combination as set forth in this application, the pre cooked starches and/or tubular starch combined with some fiber and protein will cause the matrix to remain in a firmer plastic state, until they are cooled enough to overcome the plasticity and enter in to a crystalline form. To further the expansion use of gas infused plasticizer is recommended.

The use of precooked starches and/or tubular starches under normal conditions in an extrusion system usually results a very large expansion ratio as it exists the die or the high temperature baking stage. However, due to the elastic nature of most of these long starch chains, the elastic properties in the food tend to shrink or implode in the mix, resulting in a finished product with relatively higher bulk density and harder crunch texture.

To overcome this aspect of the process, the use of higher fiber in the formula from about 1 to about 18 percent by weight and proteins from about 5 to about 60 percent by weight will retard this process of shrinkage and will result in a good textural profile with light crunch and reduction in the bulk density. This method of processing foods combined with a gas infused plasticizer will improve the bulk density of the final food even more, resulting in lighter textured product.

The protein source is preferably a full-fatted soy flour, which is ground to lower than 400 mesh. This material tends to have functional capability of the whole flour similar to an emulsifier. Other suitable protein sources are various forms of whey. These materials improve the workability of the dough while adding to the protein and fat levels of the final product, thus lowering the carbohydrate in the form of starch and sugars.

As the protein, fiber, and fat portion of the formula increases, the extrusion cooking process becomes more difficult and harder to control. The bulk density of the product is increased rather than decreased, thus giving a harder texture to the end piece. The crunchy texture of the final product becomes hard and difficult to manage. It is with this fear that most processors have a hard time using proteins in their products during high temperature extrusion.

In the case of snack and cereal manufacturing, high temperatures for a short time and high pressures are necessary to be able to generate puffing, which is essential for the textural requirement of such products. Bulk density of most snack and cereals are within the lower end of the spectrum resulting in finished product to be between about 13 to about 28 g/ml.

To reduce the bulk density, the processing is designed so that the product in mixed with moisture and kept under very high pressures and temperatures of about 1000 psi and about 280° F. for a short time so that when the precooked product within the extruder exits the die of the extruder, the vapor pressure is so great that it will force the matrix to expand and thus release the pressure of the vapor and expand the dough to much lower bulk density.

During extrusion cooking the dough may be subjected to very high temperatures of about 300 to about 400° F. for few seconds. Under normal formulations the starch or the carbohydrate portion of the formula is the dominating portion. The dough thereby tends to react positively to temperatures by superheating the moisture portion within the dough and expanding the dough once the moisture and pressure is released at the die. Starches being thermoplastic tend to react favorably to melting at high temperatures while moisture is present and expanding to reduce the bulk density.

If there any sugars or components of food, which are likely to burn at lower temperatures, are present in the high protein formulas, the dough tends to go through a carmelization or browning reaction, which in most cases is an exothermic reaction. This would mean that the extrusion cooking system will have a run away temperature during processing and cannot easily be controlled.

This process results in the final product to start at temperatures of about 265 to about 285° F. and raise to over about 300° F. in a few minutes, thus making the proteins insoluble and even resulting in crosslinking of such proteins.

If the food dough is extruded at lower temperatures, the cooking is accomplished. The expansion of the high protein dough, due to superheated moisture, is affected and minimized, resulting in a final product that is usually hard and difficult for consumption.

Due to extrusion's short residence time of about 40 to about 60 seconds and the dynamic nature of the process, chemical leavening agents are not practical and their effects are very limited. As the temperature of the protein matrix increases, the solubility of the protein molecules decreases, resulting in a stronger bond between the proteins. As the vapor pressure tries to expand the product upon leaving the die, the internal forces of the denatured and textures protein work against it, resulting in a denser product.

The greatest challenge for the food processing engineers in today's market is to be able to produce light textural snacks and cereals with high protein and fiber content while keeping the temperature below about 280° F. within an extrusion cooking system and be able to expand the product to achieve lighter textures and lower bulk density. It is this specific challenge, which is met with this invention.

As an initial step in preparing the food products, the raw ingredients are mixed in a form of flour to a substantially homogenized mixture. A plasticizing agent is the introduced in the flour mixture, preferably using highly charged gas infusion. This step may contain gas infused or just using plasticizer such as water without gas.

Dough is then formed by adding water or infused gas and then mixing to form a substantially homogenous dough. The gas infused or regular dough is then placed in formers to generate the desired form and be cut to the appropriate shape. The ability of the knives to cut the dough after it is formed also plays a major role in the functionality of the dough to be workable or not.

The cut pieces then may be introduced into 5% sodium hydroxide to produce pretzels or sprayed with acidic solution to produce shiny surface. The pretzel is then baked to form a very fast rising dough under conventional baking conditions. Use of the concentration and type of leavening agents will determine the speed and extend of the dough rising.

The liquid treated surface of the dough can then be sprinkled with various products nuts, sesame, or rock salt to give a specific taste to the final product. The baked dough is then preferably dried to a moisture content of about 2 to about 3 percent and is then cooled, where it is ready for consumption.

This technique although simple in application is able to generate great results and most effectively can be used in the formulations which contain high protein and high fiber components which prevents the extruded matrix from expanding.

The use of pre-cooked starches and/or tubular starches in the manufacturing of high protein pretzels and food articles both in baking as well as in cooking extrusion system in formulation, which require a light, textured final product. This use of pre-cooked cereal and/or tubular starch in the formula ranging in concentration from about 5 to about 85 percent by weight when combined with protein sources from Soya or legume based protein, rice, corn protein or cereal grain based proteins, and Whey, egg, or milk based protein, ranging in concentrations from about 5 to about 60 percent by weight and fiber from various sources in concentration from about 1 to about 18 percent by weight combined with gas infused plasticizer for the making of dough ranging in concentration of gas from about 0.1 to about 38 percent by volume, will result in final baked or extruded product which tends to expand greatly giving low bulk density and final light texture and mouth feel.

Such application of pre-cooked cereal and/or tubular starches are not limited to the manufacturing of pretzels, snacks and cereals but to other food articles which are used as inclusion into the making of other particulates which can be classified as high protein. Use of nucleotides and vitamins and minerals in various concentrations in the recipe will also benefit in textural and mouth feel using this process.

The texture of high protein dough is mostly very unworkable and is not stretchy and elastic as one would get from products that contain traditional sources of flour as the source of protein. Dough structures made from lower portions of traditional flour protein fall short in elasticity and thus tend to not expand or rise when leavening agents are added to the dough. The internal structure becomes very tight due to the sources of protein used, such as soy, whey, pea, or rice, thus making the final product hard and unpalatable.

The addition of larger starch granules such as potato, cassava, or similar granules in the presence of high-level plasticizers, such as water and higher temperatures, tend to provide relaxing conditions to the dough so that it reacts to the leavening agents added to the recipe, providing a rise in the dough and lighter texture in the finished product.

During cooking of a starch-based dough, a number of chemical changes take place. By providing an ample amount of plasticizer to the starch granular and in the presences of thermal energy, the starch goes from a crystalline phase to semi-crystalline phase and finally into an amorphous phase. These phase changes can be first noted by the disappearance of the Maltisian Cross under a polarized light microscope when the thermal energy is added to the starch.

This process, in turn, finally disrupts the boundaries of the amorphous starch, after which starch molecules bleed into the surrounding area, thus allowing for the cross-bonding of the starch molecule to take place leading to the development of a honeycomb structure within the finished product, e.g., a bread stick or a pretzel stick.

A more dramatic option is the addition of pre-gelatinized starches, such as potato or cassava starches, and pre-gelatinized corn or rice starches, which provide a working texture for the dough to rise with response to the leavening agents making the final product much lighter in texture. Gelatinized flours are of various kinds, which, in most cases, do not have 100% gelatinization of the starch.

It is important to use fully gelatinized starch when making high protein particles in a baking situation. It is only under full-gelatinized starch that we will get the full benefit of the functionality of the starch to bind well with the protein to develop a continuous and complete matrix.

The use of other plasticizers such as corn syrup within the dough at lower temperatures will also add to the stretch ability and elasticity of the dough, which in return will respond well to the leavening agents and will result in a good rise in the dough with an excellent, light textured final product.

The use of emulsifiers such as soy Lecithin (either in its pure form or as part of a fine grind Soya flour at 400 mesh and higher) and full fatted soy flour will also provide the cookie-like texture. This result is due to the plasticizing characteristic that lecithin develops when it is mixed with water and fat. One end of the molecule attaches itself to the water molecule while the other end attaches itself to the fat molecule at lower temperatures it will react as an effective shortening to the mix.

### EXAMPLE 1

The following tests have been conducted on a pretzel line to test the above characteristics. The result of each test run was evaluated on a scale of 1-10 the higher number being most desirable based on texture, softness, mouth feel, and taste.

The following recipes where conducted in the process of developing high protein, low carbohydrate, high fiber pretzels using a simple baking technique and tabletop pasta machine.

The results from the following tests may vary slightly during the actual scale-up processing of pretzels, depending on the parameters of the process being used and its difference between conditions used in the lab and the scale-up processing conditions such as oven temperatures, residence time, caustic strength, and temperature.

The recipes set forth in Table 1 only include the variable ingredients. All other ingredients such as leavening agents, salt, fiber and oil not included in the following recipe are added in conventionally recognized amounts and remain substantially the same to total 100 percent.

TABLE 1

| | Batch | | | | |
|---|---|---|---|---|---|
| | 1 | 2 | 3 | 4 | 5 |
| Soy Isolate | 25% | 35% | 45% | 45% | 45% |
| Whey Isolate | 0 | 0 | 0 | 5% | 5% |
| Full Fat Soy Hour (400 mesh) | 0 | 0 | 0 | 0 | 0 |
| Whole Wheat flour | 45% | 35% | 25% | 20% | 20% |
| Native Potato starch | 10% | 10% | 0 | 0 | 0 |
| Native Tapioca Starch | 0 | 0 | 10% | 0 | 0 |
| Native Corn Starch | 0 | 0 | 0 | 10% | 0 |
| Native Rice Starch | 0 | 0 | 0 | 0 | 10% |
| Corn syrup | 4% | 4% | 4% | 4% | 4% |

The batch 1 dough was stiffer than the normal dough and required more water. However it extruded well and did not show too many signs of shortness of the dough. It was harder to handle and the extrusion was not consistent with some stickiness.

The batch 2 dough would fall apart and had no cohesiveness to the matrix, causing the dough to not adhere to itself and be extruded easily.

The batch 3 dough was slightly better in functionality but still had some shortness. It could be extruded, but not as easily as conventional dough. Almost all of the doughs required higher amounts of water to be added to the mix, perhaps partly due to the functional ability of the soy isolate to absorb more water.

The batch 4 dough was stickier with lower viscosity. It lost most of its cohesiveness with very short structure and inconsistency in the flow within the extruder.

The batch 5 dough was very sticky and had lower viscosity and almost no cohesiveness or stretchability.

The pretzel samples were stored for about three weeks at room temperature and various characteristics of the pretzels were evaluated. Results of this evaluation are set forth in Table 2.

TABLE 2

| | Batch | | | | |
|---|---|---|---|---|---|
| | 1 | 2 | 3 | 4 | 5 |
| Product Texture | 7 | 6 | 8 | 5 | 3 |
| Product Softness | 4 | 3 | 6 | 5 | 1 |
| Mouth Feel | 5 | 4 | 6 | 4 | 2 |
| Overall Taste | 7 | 6 | 7 | 4 | 2 |

While four of the five batches exhibited generally good results, the batch 3 pretzels exhibited the highest overall ratings while the batch 5 pretzels exhibited the lowest overall ratings.

### EXAMPLE 2

The process of Example 1 was repeated in the next five dough batches. The primary change in these dough batches is that the starches were primarily pre-gelatinized. The composition of the batches is set forth in Table 3.

Similar to the dough compositions set forth in Table 1, other ingredients such as leavening agents, salt, fiber and oil not included in the following recipe are added in conventionally recognized amounts and remain substantially the same to total 100 percent.

TABLE 3

| | Batch | | | | |
|---|---|---|---|---|---|
| | 6 | 7 | 8 | 9 | 10 |
| Soy Isolate | 35% | 35% | 35% | 35% | 35% |
| Whey Isolate | 0 | 0 | 0 | 0 | 5% |
| Pastry Wheat flour | 35% | 35% | 35% | 35% | 35% |
| Native Tapioca Starch | 10% | 0 | 0 | 0 | 0 |
| Pre-gelatinized Potato Starch | 0 | 10% | 0 | 0 | 10% |
| Pre-gelatinized Corn Starch | 0 | 0 | 10% | 0 | 0 |
| Pre-gelatinized Rice Starch | 0 | 0 | 0 | 10% | 0 |
| Corn syrup | 4% | 4% | 4% | 4% | 4% |

The batch 6 dough was much lighter than the previous batches of dough. The workability was also very good during extrusion. Required same amount of water as previously extruded dough using higher Soy protein.

The batch 7 dough showed great improvement in workability and stretchability. The pre-gelatinized potato starch developed a consistent internal structure and elasticity.

The batch 8 dough behaved very well and had the same structural integrity as the previous additive. It was noted that it felt much lighter in texture and weaker is stretchability, which would mean the end product would be lighter in texture. Sometimes the lightness of texture may cause the final product to be too fragile and almost impossible to package and ship without breakage.

The batch 9 dough was stickier with lower viscosity and was harder to work with and extrude. The overall texture of the dough was slightly short. The stickiness of the dough resulted in difficulties to extrude the final product.

The batch 10 dough was very well developed and had slightly lower viscosity. Perhaps the lower viscosity had to do with the presence of whey protein, which usually reduces the viscosity of the dough.

The pretzel samples were stored for about three weeks at room temperature and various characteristics of the pretzels were evaluated. Results of this evaluation are set forth in Table 4.

TABLE 4

| | Batch | | | | |
|---|---|---|---|---|---|
| | 6 | 7 | 8 | 9 | 10 |
| Product Texture | 7 | 8 | 9 | 7 | 9 |
| Product Softness | 6 | 7 | 8 | 7 | 9 |
| Mouth Feel | 7 | 8 | 9 | 6 | 9 |
| Overall Taste | 6 | 7 | 8 | 7 | 9 |

Each of the pretzel batches produced in batches 6-10 exhibited overall characteristics that were significantly better than nearly all of the batch 1-5 pretzels.

### EXAMPLE 3

The process of Example 1 was repeated in the next four dough batches. The composition of the batches is set forth in Table 5. Similar to the dough compositions set forth in Table 1, other ingredients such as leavening agents, salt, fiber and oil not included in the following recipe are added in conventionally recognized amounts and remain substantially the same to total 100 percent.

TABLE 5

| | Batch | | | |
|---|---|---|---|---|
| | 11 | 12 | 13 | 14 |
| Soy Isolate | 37% | 37% | 37% | 37% |
| Whey Isolate | 6 | 7% | 0 | 0 |
| Full Fat Soy Flour (400 mesh) | 0 | 12% | 12% | 8.5% |
| Pastry Wheat flour | 12% | 4% | 0 | 0 |
| Native Tapioca Starch | 10% | 10% | 10% | 11.5% |
| Pre-gelatinized Corn Starch | 15% | 10% | 15% | 11% |
| Sesame Seeds | 0 | 0 | 6% | 12% |
| Corn syrup | 4% | 4% | 0 | 0 |
| Cane juice syrup | 0 | 0 | 4% | 4% |

The batch 11 dough was much lighter than the previous batches of dough and the workability was also very good during extrusion. This dough required approximately the same amount of water as previously extruded dough using higher Soy protein. The viscosity of the dough was much lower and it seems that the presence of pasty flour reduced the elastic characteristic of the dough.

The batch 12 dough showed great improvement in workability and stretchability. The pre-gelatinized cornstarch combined with the Tapioca starch worked best and it developed a consistent internal structure and elasticity. The addition of the full fatted soy flour tends to make the dough less sticky but more fatty. This dough held itself together well and there were no signs of dough being short during extrusion. The viscosity of the dough was again very low and could use a slight finning of the dough in order to be cut more easily.

To keep the protein level of the product high and not jeopardize the textural integrity of the finished product, we added sesame to the dough. Sesame was used because it has fat and protein with no carbohydrates that would be in the form of starch. The batch 13 dough was well developed had good stretchability and a viscoelastic property. The overall workability was also improved and the product seemed to be developing and cutting easily as it was left to sit to rise.

The batch 14 dough was very well developed and had slightly higher viscosity. This characteristic added to the workability of the dough and was able to extrude and cut easily while it was rising. It did not require much proofing time and can easily be marketed as a very high protein pretzel with very high protein and fiber.

The pretzel samples were stored for about three weeks at room temperature and various characteristics of the pretzels were evaluated. Results of this evaluation are set forth in Table 6.

TABLE 6

Batch

| | 11 | 12 | 13 | 14 |
|---|---|---|---|---|
| Product Texture | 8 | 9 | 9 | 10 |
| Product Softness | 8 | 8 | 10 | 9 |
| Mouth Feel | 9 | 9 | 9 | 10 |
| Overall Taste | 8 | 8 | 9 | 10 |

Each of the pretzel batches produced in batches 11-14 exhibited overall characteristics that were significantly better than nearly all of the batch 1-5 pretzels. Of the fourteen batches of pretzels produced in the examples, batches 13 and 14 exhibited the highest overall characteristics.

From the above experiment it was noted that the addition of soy protein to the product would increase the hardness and reduce the taste characteristics. To keep the high protein concept intact, we worked with adding pre-gelatinized corn or potato starch, which improved the textural characteristic of the final product.

This step was then followed by the addition of finely ground soy flour, which improved the textural quality of the product even further. The removal of wheat flour actually helped to build a better dough and a high quality finished product when used in conjunction with pre-gelled starch and native tapioca starch.

It is contemplated that features disclosed in this application, as well as those described in the above applications incorporated by reference, can be mixed and matched to suit particular circumstances. Various other modifications and changes will be apparent to those of ordinary skill.

1. A high protein food product comprising:
at least one starch source at a concentration of about 5 to about 85 percent by weight, wherein at least a portion of the starch source is a pre-cooked cereal and/or tubular starch;
a protein source at a concentration of about 5 to about 60 percent by weight;
a fiber source at a concentration of about 1 to about 18 percent by weight; and
a plasticizer at a concentration of about 0.1 to about 38 percent by weight.

2. The high protein food product of claim 1, wherein the starch source comprises corn starch, corn flour, waxy maize starches, sago starch, cassava starch, tapioca starch, potato starch, rice starch, or combinations thereof.

3. The high protein food product of claim 1, wherein the tubular starches is pre-gelatinized or the cereal starch is pre-cooked.

4. The high protein food product of claim 1, wherein the protein source is soy isolate, soy flour, soy protein, whey isolate, whey protein, legume protein, grain-based protein, milk-based protein, egg and combinations thereof.

5. The high protein food product of claim 4, wherein the protein source has an average mesh size of less than 400.

6. The high protein food product of claim 1, wherein the plasticizer is a gas infused plasticizer.

7. The high protein food product of claim 1, and further comprising a sweetener.

8. The high protein food product of claim 7, wherein the sweetener comprises corn syrup, cane juice syrup, sugar, nutritive and non-nutritive sweeteners, and combinations thereof.

9. The high protein food product of claim 1, and further comprising pieces of high protein seeds or inclusions.

10. The high protein food product of claim 1, and further comprising a leavening agent.

11. The high protein food product of claim 1, wherein the high protein food product has a moisture content of less than 5 percent by weight.

12. The high protein food product of claim 1, wherein the high protein food product is a pretzel.

13. A method of preparing a high protein food product comprising:
preparing a mixture from at least one starch source, a protein source and a fiber source, wherein the at least one starch source is at a concentration of about 5 to about 85 percent by weight, wherein at least a portion of the starch source is a pre-cooked cereal and/or tubular starch, wherein the protein source is at a concentration of about 5 to about 60 percent by weight, wherein the fiber source is at a concentration of about 1 to about 18 percent by weight;
mixing the mixture with a plasticizer to form a dough, wherein the plasticizer is at a concentration of about 0.1 to about 38 percent by weight;
forming the dough into a desired shape; and
cooking the dough to form the high protein food product.

14. The method of claim 13, wherein the dough is formed and cooked using an extruder.

15. The method of claim 14, wherein the extruder causes the dough to expand as it exits the extruder.

16. The method of claim 13, wherein the dough is cooked at a temperature of about 250 to about 400° F.

17. The method of claim 13, wherein the dough is cooked for about 40 to about 60 seconds.

18. The method of claim 13, wherein the starch source comprises corn starch, corn flour, waxy maize starches, sago starch, cassava starch, tapioca starch, potato starch, rice starch, or combinations thereof.

19. The method of claim 13, wherein the tubular starch is pre-gelatinized or the cereal starch is pre-cooked.

20. The method of claim 13, wherein the protein source is soy isolate, soy flour, soy protein, whey isolate, whey protein, legume protein, grain-based protein, milk-based protein, egg and combinations thereof.

21. The method of claim 13, and further comprising grinding the protein source to an average mesh size of less than 400 prior to mixing into the dough.

22. The method of claim 13, wherein the plasticizer is a gas infused plasticizer.

23. The method of claim 13, and further comprising mixing a sweetener into the dough.

24. The method of claim 23, wherein the sweetener comprises corn syrup, cane juice syrup, sugar, nutritive and non-nutritive sweeteners, and combinations thereof.

25. The method of claim 13, and further comprising mixing pieces of high protein seeds or inclusions into the dough.

26. The method of claim 13, and further comprising mixing a leavening agent into the dough.

27. The method of claim 13, wherein the high protein food product has a moisture content of less than 5 percent by weight.

28. The method of claim 13, wherein the high protein food product is a pretzel.
